(19) United States
(12) Patent Application Publication
(10) Pub. No.: US 2025/0102055 A1
(43) Pub. Date: Mar. 27, 2025

(54) DRIVE PULLEY FOR CONTINUOUSLY VARIABLE TRANSMISSION, CONTINUOUSLY VARIABLE TRANSMISSION, AND OFF-ROAD VEHICLE

(71) Applicant: KAWASAKI MOTORS, LTD., Hyogo (JP)

(72) Inventor: Yuki NAKAMURA, Akashi-shi (JP)

(73) Assignee: KAWASAKI MOTORS, LTD., Hyogo (JP)

(21) Appl. No.: 18/473,758

(22) Filed: Sep. 25, 2023

(51) Int. Cl. F16H 55/56; F16H 9/18

(52) U.S. Cl. CPC F16H 55/563; F16H 9/18

(57) ABSTRACT

A drive pulley 20 for a continuously variable transmission includes a drive shaft 21, a fixed sheave 22, a movable sheave 23, a spider 24, a support 50 disposed on the movable sheave 23—and including a first receiving portion 51 and a second receiving portion 52, a pin 60 including a first end portion 61 supported on the first receiving portion 51 by being inserted into a first through-hole 511 of the first receiving portion 51 and a second end portion 62 supported on the second receiving portion 52 by being inserted into a second through-hole 521 of the second receiving portion 52, a centrifugal weight 40 attached to the pin 60, and a retaining ring 65 preventing removal of the first end portion 61 of the pin 60 from the first through-hole 511.

### FIELD

The technique disclosed herein relates to a drive pulley for a continuously variable transmission, a continuously variable transmission, and an off-road vehicle.

### BACKGROUND

Conventionally, a drive pulley used for a continuously variable transmission has been known. For example, a drive pulley for a continuously variable transmission as disclosed in Patent Literature 1 (U.S. Pat. No. 4,464,144) has a drive shaft, a fixed sheave, a movable sheave, a spider, and a centrifugal weight. The fixed sheave is fixed to the drive shaft in an axial direction and a circumferential direction. The movable sheave is movable in the axial direction relative to the drive shaft, and is fixed to the drive shaft in the circumferential direction. The spider is fixed to the drive shaft in the axial direction and the circumferential direction. The centrifugal weight is turnably attached to the movable sheave. The centrifugal weight turns according to centrifugal force generated by rotation of the drive shaft, thereby pressing the spider. The movable sheave moves in the axial direction by reactive force generated by pressing of the spider by the centrifugal weight.

### SUMMARY

In the above-described drive pulley for the continuously variable transmission, the centrifugal weight is attached to the movable sheave with a bolt and a nut. The bolt may turn so as to follow turn of the centrifugal weight, leading to a probability that the nut is loosened. In order to prevent nut loosening, a nut with a lock is used in some cases. However, the cost for the nut with the lock is high.

The technique disclosed herein has been made in view of the above-described points, and an object thereof is to reduce screw loosening and reduce a cost.

A drive pulley for a continuously variable transmission as disclosed herein includes a drive shaft, a fixed sheave fixed to the drive shaft in an axial direction and a circumferential direction, a movable sheave movable in the axial direction relative to the drive shaft and fixed to the drive shaft in the circumferential direction, a spider fixed to the drive shaft in the axial direction and the circumferential direction, a support disposed on one of the movable sheave or the spider and including a first receiving portion and a second receiving portion located apart from each other, a pin including a first end portion supported on the first receiving portion with inserted into a first through-hole of the first receiving portion and a second end portion supported on the second receiving portion with inserted into a second through-hole of the second receiving portion, a centrifugal weight located between the first receiving portion and the second receiving portion, attached to the pin so as to turn according to centrifugal force generated by rotation of the drive shaft, and turning by rotation of the drive shaft to press the other one of the movable sheave or the spider and move the movable sheave in the axial direction, and a retaining ring preventing removal of the first end portion of the pin from the first through-hole.

A continuously variable transmission disclosed herein includes a drive pulley receiving torque from a drive source, a driven pulley outputting the torque to a drive wheel, and a belt wound between the drive pulley and the driven pulley. The drive pulley includes a drive shaft, a fixed sheave fixed to the drive shaft in an axial direction and a circumferential direction, a movable sheave movable in the axial direction relative to the drive shaft and fixed to the drive shaft in the circumferential direction, a spider fixed to the drive shaft in the axial direction and the circumferential direction, a support disposed on one of the movable sheave or the spider and including a first receiving portion and a second receiving portion located apart from each other, a pin including a first end portion supported on the first receiving portion with inserted into a first through-hole of the first receiving portion and a second end portion supported on the second receiving portion with inserted into a second through-hole of the second receiving portion, a centrifugal weight located between the first receiving portion and the second receiving portion, attached to the pin so as to turn according to centrifugal force generated by rotation of the drive shaft, and turning by rotation of the drive shaft to press the other one of the movable sheave or the spider and move the movable sheave in the axial direction, and a retaining ring preventing removal of the first end portion of the pin from the first through-hole.

An off-road vehicle disclosed herein includes a drive source, a drive wheel, and a continuously variable transmission transmitting the torque of the drive source to the drive wheel. The continuously variable transmission includes a drive pulley receiving the torque from the drive source, a driven pulley outputting the torque to the drive wheel, and a belt wound between the drive pulley and the driven pulley. The drive pulley includes a drive shaft, a fixed sheave fixed to the drive shaft in an axial direction and a circumferential direction, a movable sheave movable in the axial direction relative to the drive shaft and fixed to the drive shaft in the circumferential direction, a spider fixed to the drive shaft in the axial direction and the circumferential direction, a support disposed on one of the movable sheave or the spider and including a first receiving portion and a second receiving portion located apart from each other, a pin including a first end portion supported on the first receiving portion with inserted into a first through-hole of the first receiving portion and a second end portion supported on the second receiving portion with inserted into a second through-hole of the second receiving portion, a centrifugal weight located between the first receiving portion and the second receiving portion, attached to the pin so as to turn according to centrifugal force generated by rotation of the drive shaft, and turning by rotation of the drive shaft to press the other one of the movable sheave or the spider and move the movable sheave in the axial direction, and a retaining ring preventing removal of the first end portion of the pin from the first through-hole.

The drive pulley for the continuously variable transmission is configured so that screw loosening can be reduced and the cost can be reduced.

The continuously variable transmission is configured so that screw loosening can be reduced in the drive pulley and the cost can be reduced.

The off-road vehicle is configured so that screw loosening can be reduced in the drive pulley and the cost can be reduced.

### BRIEF DESCRIPTION OF THE DRAWINGS

FIG. 1 is a side view of a utility vehicle.

FIG. 2 is a sectional view of a continuously variable transmission.

FIG. 3 is a perspective view of a drive pulley.

FIG. 4 is a sectional view of the drive pulley.

FIG. 5 is a sectional view of the drive pulley in a state of a centrifugal weight having turned.

FIG. 6 is a sectional view of a driven pulley.

FIG. 7 is a sectional view along a VII-VII line in FIG. 4.

FIG. 8 is an enlarged view from the direction of an arrow A in FIG. 7.

FIG. 9 is a sectional view showing the state of attachment of a support and a pin in a drive pulley according to a first modification.

FIG. 10 is a sectional view showing the state of attachment of a support and a pin in a drive pulley according to a second modification.

FIG. 11 is a sectional view showing the state of attachment of a support and a pin in a drive pulley according to a third modification.

### DESCRIPTION OF EMBODIMENTS

Hereinafter, an exemplary embodiment will be described in detail based on the drawings.

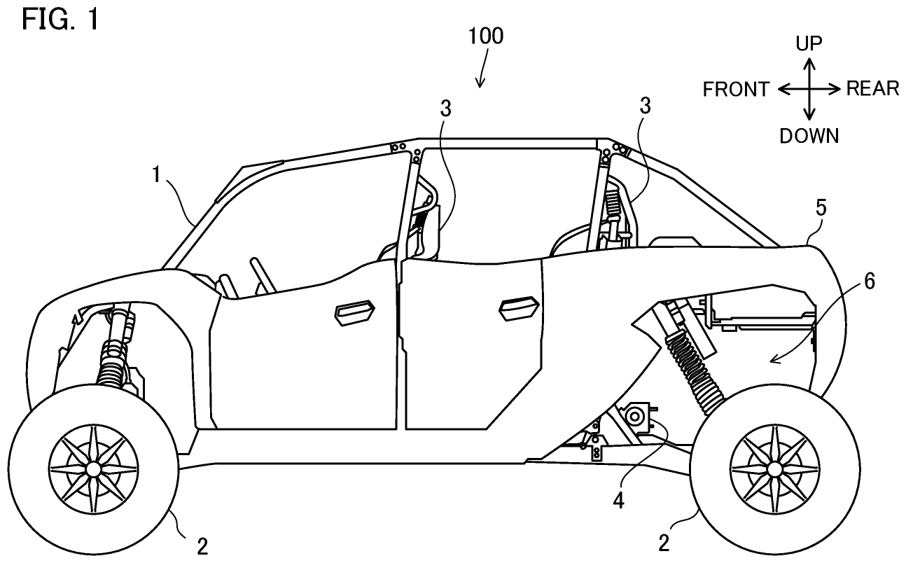

FIG. 1 is a side view of a utility vehicle 100. The utility vehicle 100 can travel off road. The utility vehicle 100 is one example of an off-road vehicle. Hereinafter, the utility vehicle 100 will also be merely referred to as a “vehicle 100.”

In the present disclosure, each component of the vehicle 100 will be described using a direction with respect to the vehicle 100. Specifically, a “front” means the front of the vehicle 100 in a vehicle front-rear direction, and a “rear” means the rear of the vehicle 100 in the vehicle front-rear direction. A “left” means the left when facing the front of the vehicle 100, and a “right” means the right when facing the front of the vehicle 100. Note that a right-left direction will also be referred to as a “vehicle width direction.”

The vehicle 100 includes a vehicle body frame 1, wheels 2, seats 3, and a power unit 4. The vehicle 100 may further include a panel 5. The wheels 2 include right and left front wheels and right and left rear wheels. That is, the vehicle 100 is a four-wheeled vehicle. The seats 3 include a front seat and a rear seat. The power unit 4 has an engine 7, a continuously variable transmission 10 that changes the output rotation speed of the engine 7, a power generator that generates power by the power of the engine 7, a battery that stores the power generated by the power generator, etc. The power unit 4 is housed in an engine room 6. The engine room 6 is in rear in the vehicle body frame 1, specifically in rear of the rear seat.

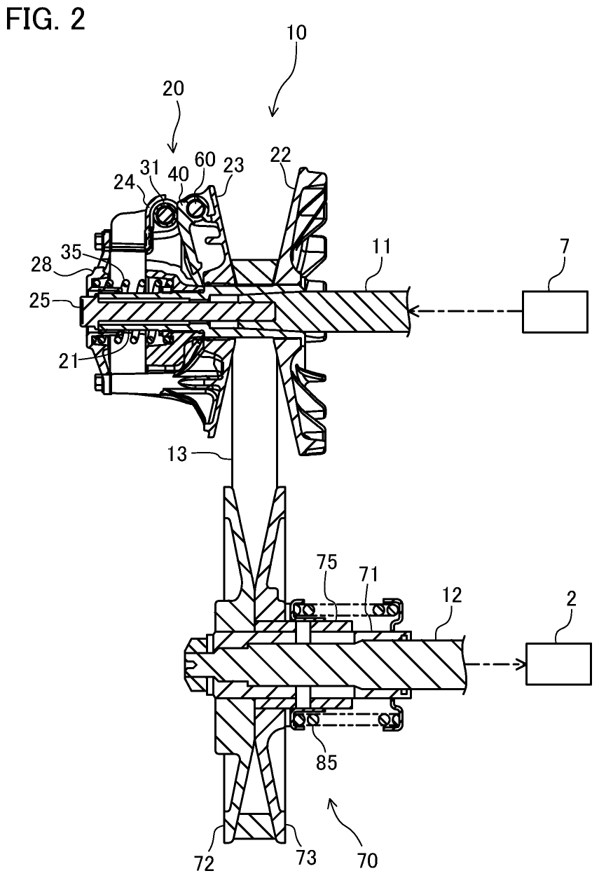

FIG. 2 is a sectional view of the continuously variable transmission 10. The continuously variable transmission 10 includes a drive pulley 20, a driven pulley 70, and a belt 13. The drive pulley 20 is one example of a drive pulley for a continuously variable transmission.

The drive pulley 20 receives torque input from the engine 7. Specifically, the drive pulley 20 is coupled to the engine 7 through an input shaft 11. The input shaft 11 is, for example, a crankshaft. The engine 7 is one example of a drive source.

The driven pulley 70 outputs the torque to the wheel 2. Specifically, the driven pulley 70 is coupled to the wheel 2 through an output shaft 12. The output shaft 12 is, for example, a drive shaft. Note that the output shaft 12 may be an input shaft of a sub-transmission (gear transmission) coupled to the wheel 2.

In this example, the driven pulley 70 outputs the torque to the rear wheels. That is, the rear wheels are drive wheels, and the vehicle 100 is operated in two-wheel drive. Note that the front wheels and the rear wheels may be drive wheels and the vehicle 100 is operated in four-wheel drive in this case.

The belt 13 is wound between the drive pulley 20 and the driven pulley 70. The belt 13 is a so-called V-belt. Specifically, the inner peripheral side width of the belt 13 is smaller than the outer peripheral side width of the belt 13.

The torque (rotation power) of the engine 7 is transmitted to the drive pulley 20 through the input shaft 11, rotation of the drive pulley 20 is transmitted to the driven pulley 70 through the belt 13, and rotation of the driven pulley 70 is transmitted to the wheels 2 through the output shaft 12. In this manner, the continuously variable transmission 10 transmits the torque of the engine 7 to the wheels 2.

The drive pulley 20 is configured such that a radial position at which the belt 13 is wound therearound is changeable. The driven pulley 70 is configured such that a radial position at which the belt 13 is wound therearound is changeable. Thus, the continuously variable transmission 10 transmits the torque to the wheels 2 while changing the rotation speed of the engine 7.

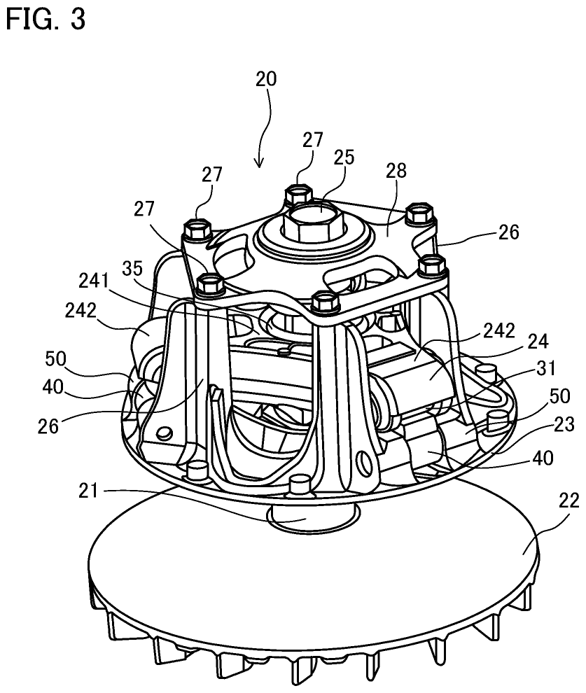

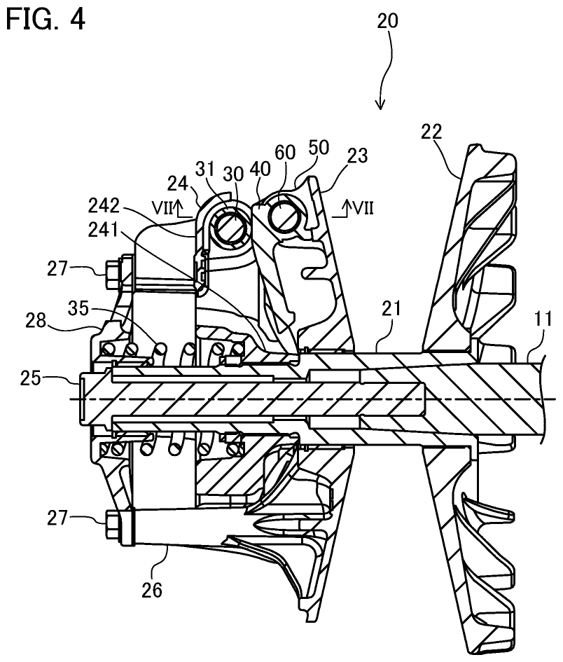

FIG. 3 is a perspective view of the drive pulley 20. FIG. 4 is a sectional view of the drive pulley 20. The drive pulley 20 includes a drive shaft 21, a fixed sheave 22, a movable sheave 23, and a spider 24.

Hereinafter, unless otherwise specified, terms “axial direction,” “circumferential direction,” and “radial direction” regarding the drive pulley 20 will be described with reference to the drive shaft 21. Specifically, the “axial direction” is the direction of the axis of the drive shaft 21, the “circumferential direction” is a circumferential direction about the axis of the drive shaft 21, and the “radial direction” is a radial direction about the axis of the drive shaft 21.

The drive shaft 21 is in a tubular shape. The input shaft 11 is fitted in one end portion of the drive shaft 21, a bolt 25 is inserted into the other end portion of the drive shaft 21, and the bolt 25 is screwed into the input shaft 11. With this configuration, the drive shaft 21 is integrally joined to the input shaft 11 with the bolt 25.

The fixed sheave 22 is in a discoid shape. The front surface of the fixed sheave 22 is in a conical shape. The fixed sheave 22 has fins on the back surface thereof. The fixed sheave 22 has a hole at the center of the disc.

The fixed sheave 22 is attached to the one end portion of the drive shaft 21 such that the front surface of the fixed sheave 22 faces the other end portion side of the drive shaft 21. The one end portion of the drive shaft 21 is inserted into the hole of the fixed sheave 22, and the outer peripheral surface of the one end portion of the drive shaft 21 and the inner peripheral surface of the hole of the fixed sheave 22 are screwed to each other. With this configuration, the fixed sheave 22 is integrally joined to the drive shaft 21. That is, the fixed sheave 22 is fixed to the drive shaft 21 in the axial direction and the circumferential direction.

The spider 24 is located on the other end portion side of the drive shaft 21 with respect to the fixed sheave 22. The spider 24 has a boss portion 241 and arm portions 242 radially extending outward from the boss portion 241 in the radial direction. In this example, the spider 24 has three arm portions 242.

The drive shaft 21 is inserted into a hole of the boss portion 241, and the outer peripheral surface of the drive shaft 21 and the inner peripheral surface of the hole of the boss portion 241 are screwed to each other. With this configuration, the spider 24 is integrally joined to the drive shaft 21. That is, the spider 24 is fixed to the drive shaft 21 in the axial direction and the circumferential direction.

A pressure pin 30 is attached to an outer tip end portion of the arm portion 242 in the radial direction. A roller 31 is turnably supported on the pressure pin 30.

The movable sheave 23 is located between the fixed sheave 22 and the spider 24. The movable sheave 23 is in a discoid shape. The front surface of the movable sheave 23 is in a conical shape. The front surface of the movable sheave 23 faces the front surface of the fixed sheave 22. The belt 13 is located between the front surface of the fixed sheave 22 and the front surface of the movable sheave 23, and is sandwiched between the front surface of the fixed sheave 22 and the front surface of the movable sheave 23.

The movable sheave 23 has a hole at the center of the disc. The drive shaft 21 is inserted into the hole of the movable sheave 23, and the movable sheave 23 is fitted onto the drive shaft 21.

The movable sheave 23 has, on the back surface thereof, guide rods 26 extending along the drive shaft 21. In this example, the movable sheave 23 has six guide rods 26. The guide rod 26 protrudes from the outer peripheral edge of the movable sheave 23 toward the other end portion of the drive shaft 21. The guide rods 26 are located at equal intervals along the outer periphery of the movable sheave 23. A cover 28 is attached to the tip ends of the guide rods 26 through bolts 27. The guide rods 26 are coupled to the cover 28 along the circumferential direction of the cover 28. The cover 28 has a hole, and the other end portion of the drive shaft 21 is inserted into the hole of the cover 28. With this configuration, the cover 28 is integrally joined to the movable sheave 23 through the guide rods 26.

The guide rods 26 sandwich each arm portion 242 of the spider 24 from both sides in the circumferential direction. That is, each arm portion 242 is positioned between adjacent two of the guide rods 26 in the circumferential direction. With this configuration, the position of the movable sheave 23 is determined, together with the guide rods 26, in the circumferential direction by the arm portions 242, and is movably guided in the axial direction by the arm portions 242. That is, the movable sheave 23 is movable in the axial direction relative to the drive shaft 21, and is fixed to the drive shaft 21 in the circumferential direction.

Supports 50 are disposed on the back surface of the movable sheave 23. The supports 50 are integrally connected to the movable sheave 23. In this example, three supports 50 are disposed on the movable sheave 23. Each support 50 is located between adjacent two of the guide rods 26 in the circumferential direction so as to face the arm portion 242.

A pin 60 is attached to the support 50, and a centrifugal weight 40 is attached to the pin 60. The centrifugal weight 40 is attached to the pin 60 so as to turn according to centrifugal force generated by rotation of the drive shaft 21. Specifically, one end portion of the centrifugal weight 40 is supported on the pin 60, and the other end portion of the centrifugal weight 40 is a free end. The one end portion of the centrifugal weight 40 is positioned outside in the radial direction, and the other end portion of the centrifugal weight 40 is positioned inside in the radial direction. With this configuration, the centrifugal weight 40 turns about the pin 60 by the centrifugal force generated by rotation of the drive shaft 21 such that the other end portion of the centrifugal weight 40 draws a circular trajectory about the pin 60.

The centrifugal weight 40 contacts the roller 31. When turning by rotation of the drive shaft 21, the centrifugal weight 40 presses the spider 24 through the roller 31, and moves the movable sheave 23 in the axial direction by reactive force generated by pressing. That is, the centrifugal weight 40 moves the movable sheave 23 to the fixed sheave 22 side when turning by rotation of the drive shaft 21.

There is a spring 35 between the cover 28 and the spider 24. The spring 35 biases the cover 28 in a direction of the cover 28 being separated from the spider 24 in the axial direction. Accordingly, the spring 35 biases the movable sheave 23 in a direction of the movable sheave 23 approaching the spider 24 in the axial direction. That is, the spring 35 biases the movable sheave 23 in a direction of the movable sheave 23 being separated from the fixed sheave 22 in the axial direction. The spring 35 is, for example, a compressed coil spring.

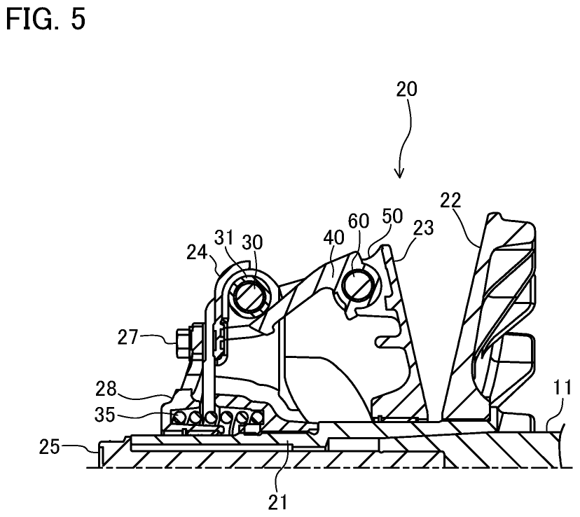

Subsequently, the function of the drive pulley 20 will be described. FIG. 5 is a sectional view of the drive pulley 20 in a state of the centrifugal weight 40 having turned.

As shown in FIG. 4, when the drive shaft 21 does not rotate, no centrifugal force is generated on the centrifugal weight 40, and therefore, the centrifugal weight 40 does not turn. In this state, the movable sheave 23 is at a position farthest from the fixed sheave 22 because the movable sheave 23 is biased by the spring 35.

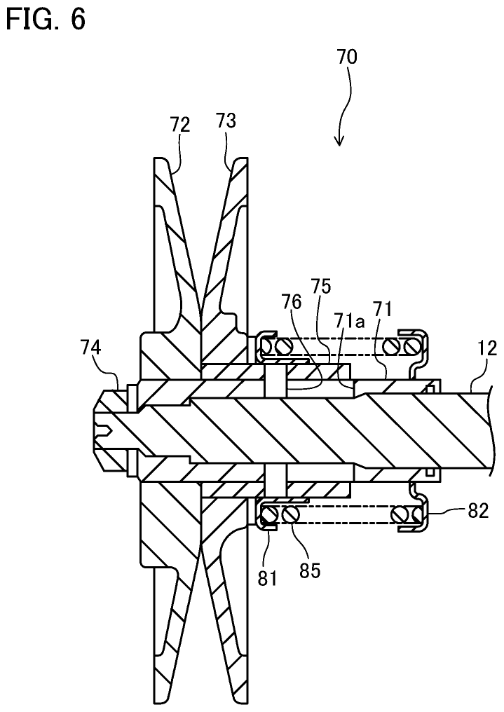

As shown in FIG. 5, when the drive shaft 21 rotates, the centrifugal weight 40 turns. In this state, the centrifugal weight 40 presses the roller 31, and in response to the reactive force generated by pressing, moves the movable sheave 23 to the fixed sheave 22 side along the axial direction against biasing by the spring 35. As the rotation speed of the drive shaft 21 increases, the centrifugal force acting on the centrifugal weight 40 increases. Accordingly, the range of motion of the centrifugal weight 40 increases, and a force of the centrifugal weight 40 pressing the roller 31 increases. As a result, the movable sheave 23 approaches the fixed sheave 22. FIG. 6 is a sectional view of the driven pulley 70. The driven pulley 70 includes a drive shaft 71, a fixed sheave 72, and a movable sheave 73.

Hereinafter, unless otherwise specified, terms “axial direction,” “circumferential direction,” and “radial direction” regarding the driven pulley 70 will be described with reference to the drive shaft 71. Specifically, the “axial direction” is the direction of the axis of the drive shaft 71, the “circumferential direction” is a circumferential direction about the axis of the drive shaft 71, and the “radial direction” is a radial direction about the axis of the drive shaft 71.

The drive shaft 71 is in a tubular shape. One end portion of the output shaft 12 is fitted in the drive shaft 71, and a nut 74 is fastened to a tip end portion of the one end portion of the output shaft 12. With this configuration, the drive shaft 71 is integrally joined to the output shaft 12.

The fixed sheave 72 is in a discoid shape. The front surface of the fixed sheave 72 is in a conical shape. The fixed sheave 72 has a hole at the center of the disc.

The fixed sheave 72 is attached to one end portion of the drive shaft 71 such that the front surface of the fixed sheave 72 faces the other end portion side of the drive shaft 71. The one end portion of the drive shaft 71 is inserted into the hole of the fixed sheave 72, and the outer peripheral surface of the one end portion of the drive shaft 71 and the inner peripheral surface of the hole of the fixed sheave 72 are screwed to each other. With this configuration, the fixed sheave 72 is integrally joined to the drive shaft 71. That is, the fixed sheave 72 is fixed to the drive shaft 71 in the axial direction and the circumferential direction.

The movable sheave 73 is in a discoid shape. The front surface of the movable sheave 73 is in a conical shape. The front surface of the movable sheave 73 faces the front surface of the fixed sheave 72. The belt 13 is located between the front surface of the fixed sheave 72 and the front surface of the movable sheave 73, and is sandwiched between the front surface of the fixed sheave 72 and the front surface of the movable sheave 73.

The movable sheave 73 has a hole at the center of the disc. A sleeve 75 is fixed to the hole of the movable sheave 73. The sleeve 75 is fitted onto the drive shaft 71. A roller 76 is attached to the sleeve 75 so as to protrude inward in the radial direction. The drive shaft 71 has, in the outer surface thereof, a linear groove 71a extending in the axial direction. The roller 76 is fitted in the groove 71a. With this configuration, the position of the movable sheave 73 is determined, together with the sleeve 75, in the circumferential direction by the roller 76 and the groove 71a, and the movable sheave 73 is movable in the axial direction along the groove 71a. That is, the movable sheave 73 is movable in the axial direction relative to the drive shaft 71, and is fixed to the drive shaft 71 in the circumferential direction.

A first ring 81 is fixed to the sleeve 75, and a second ring 82 is fixed to the drive shaft 71. The first ring 81 is located on the opposite side of the movable sheave 73 from the fixed sheave 72. The second ring 82 is located on the opposite side of the first ring 81 from the movable sheave 73.

There is a spring 85 between the first ring 81 and the second ring 82. The spring 85 biases the first ring 81 in a direction of the first ring 81 being separated from the second ring 82 in the axial direction. That is, the spring 85 biases the movable sheave 73 in a direction of the movable sheave 73 approaching the fixed sheave 72 in the axial direction. The spring 85 is, for example, a compressed coil spring.

Subsequently, the function of the continuously variable transmission 10 will be described. As shown in FIG. 2, when the rotation speed of the engine 7 is low, i.e., the rotation speed of the input shaft 11 is low, the centrifugal force acting on the centrifugal weight 40 is small, and therefore, the range of motion of the centrifugal weight 40 is small and the force of the centrifugal weight 40 pressing the roller 31 is small. As a result, the movable sheave 23 is separated from the fixed sheave 22, and the belt 13 is positioned inside in the radial direction of the drive pulley 20. That is, the effective diameter of the drive pulley 20 decreases.

On the other hand, in the driven pulley 70, the tension of the belt 13 generated by rotation of the drive pulley 20 acts on the driven pulley 70, and the driven pulley 70 rotates accordingly. In this state, the tension of the belt 13 is small, and therefore, the belt 13 is positioned outside in the radial direction of the driven pulley 70. That is, the effective diameter of the driven pulley 70 increases.

As described above, when the rotation speed of the engine 7 is low, the reduction ratio of the continuously variable transmission 10 is high.

As the rotation speed of the engine 7 increases, the centrifugal force acting on the centrifugal weight 40 increases and the force of the centrifugal weight 40 pressing the roller 31 increases in the drive pulley 20. As a result, the movable sheave 23 approaches the fixed sheave 22 as shown in FIG. 5. When the movable sheave 23 moves to the fixed sheave 22 side, the belt 13 moves outward in the radial direction of the drive pulley 20. That is, the effective diameter of the drive pulley 20 increases.

On the other hand, in the driven pulley 70, the tension of the belt 13 increases, and the inward force of the belt 13 in the radial direction of the driven pulley 70 increases. Accordingly, the movable sheave 73 moves in a direction of being separated from the fixed sheave 72 against the spring force of the spring 85, and the belt 13 moves inward in the radial direction of the driven pulley 70. That is, the effective diameter of the driven pulley 70 decreases.

As described above, as the rotation speed of the engine 7 increases, the reduction ratio of the continuously variable transmission 10 continuously decreases.

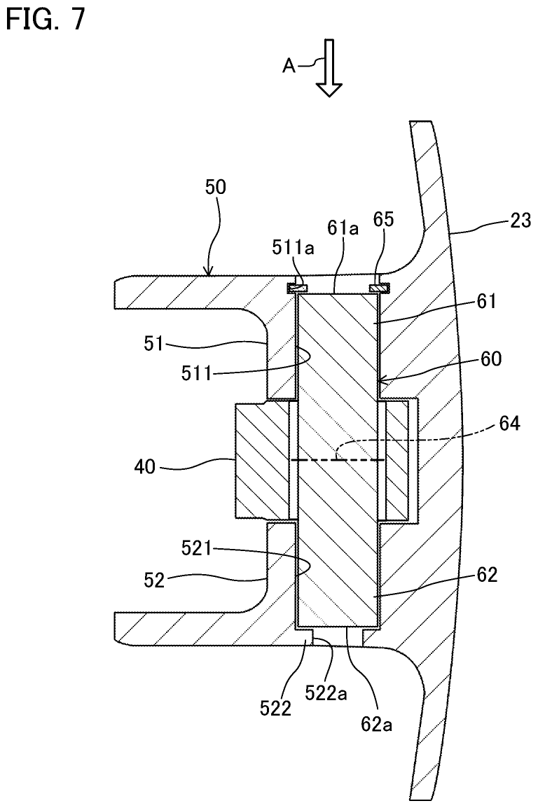

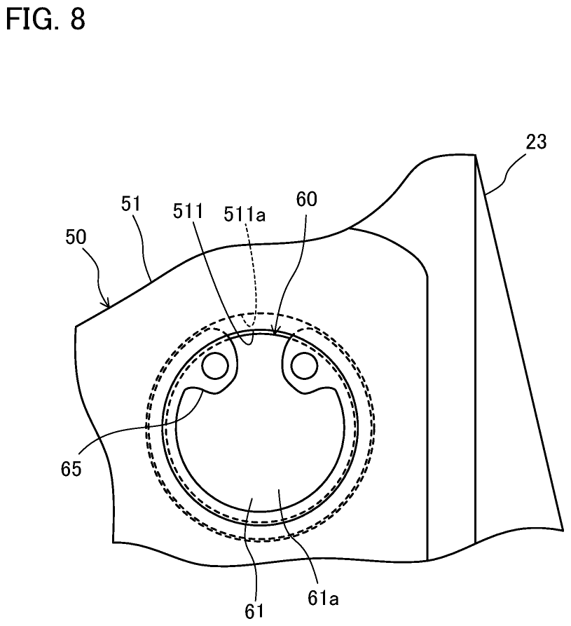

Next, the state of attachment of the support 50 and the pin 60 in the drive pulley 20 will be described. FIG. 7 is a sectional view along a VII-VII line in FIG. 4. FIG. 7 is shown without the spider 24, the pressure pin 30, and the roller 31. FIG. 8 is an enlarged view from the direction of an arrow A in FIG. 7.

The support 50 includes a first receiving portion 51 and a second receiving portion 52. The first receiving portion 51 and the second receiving portion 52 are located apart from each other. The centrifugal weight 40 is located between the first receiving portion 51 and the second receiving portion 52. The first receiving portion 51 has a first through-hole 511. The second receiving portion 52 has a second through-hole 521. The axis of the first through-hole 511 and the axis of the second through-hole 521 are positioned on the same line.

The pin 60 includes a first end portion 61 and a second end portion 62. The first end portion 61 is supported on the first receiving portion 51 with inserted into the first through-hole 511 of the first receiving portion 51. The second end portion 62 is supported on the second receiving portion 52 with inserted into the second through-hole 521 of the second receiving portion 52. That is, the pin 60 are supported on both sides by the first receiving portion 51 and the second receiving portion 52.

The drive pulley 20 has a retaining ring 65. The retaining ring 65 prevents removal of the first end portion 61 of the pin 60 from the first through-hole 511. The retaining ring 65 is in an annular shape having both end portions, and these both end portions face each other with a space therebetween. The retaining ring 65 is, for example, a circlip or a snap ring.

The retaining ring 65 is attached to the inner surface of the first through-hole 511, and contacts a first end surface 61a of the first end portion 61 of the pin 60 to determine the position of the first end surface 61a inside the first through-hole 511. Specifically, the first through-hole 511 has, in the inner surface thereof, a groove 511a. The groove 511a extends in a circumferential direction about the axis of the first through-hole 511. The retaining ring 65 is fitted in the groove 511a. Specifically, an outer peripheral portion of the retaining ring 65 is fitted in the groove 511a, and an inner peripheral portion of the retaining ring 65 contacts the first end surface 61a. With this configuration, removal of the pin 60 from the first through-hole 511 in the direction opposite to the second receiving portion 52 is restricted.

The retaining ring 65 is detachably attached to the groove 511a. Specifically, the inner diameter of the retaining ring 65 is decreased with a tool such as pliers inserted into holes in both end portions of the retaining ring 65, and in this manner, the retaining ring 65 can be detached from the groove 511a. By a similar process, the detached retaining ring 65 can be attached to the groove 511a.

The second receiving portion 52 has a bottom portion 522 at an end portion of the second through-hole 521 opposite to an end portion on the first receiving portion 51 side. The bottom portion 522 contacts a second end surface 62a of the second end portion 62 of the pin 60 to determine the position of the second end surface 62a inside the second through-hole 521. That is, removal of the pin 60 from the second through-hole 521 in the direction opposite to the first receiving portion 51 is restricted.

The bottom portion 522 has a hole 522a communicating with the second through-hole 521. The inner diameter of the hole 522a is smaller than the inner diameter of the second through-hole 521. Here, the inner diameter is, for example, an equivalent circle diameter.

The pin 60 may be symmetrical with respect to a plane 64 passing the center of the length of the pin 60 in the axial direction thereof and extending perpendicularly to the axis of the pin 60. That is, the shape of the first end portion 61 and the shape of the second end portion 62 may be the same as each other.

The above-described drive pulley 20 has the retaining ring 65 that prevents removal of the first end portion 61 of the pin 60 from the first through-hole 511. Since the retaining ring 65 is used for preventing removal of the pin 60 as described above, screw loosening is reduced. The cost for the retaining ring 65 can be lower as compared to a nut with a lock.

Since the retaining ring 65 is used for preventing removal of the pin 60, time and effort required for fastening a bolt and a nut as in the prior art can be saved and time and effort required for attaching the centrifugal weight 40 can be reduced when the centrifugal weight 40 is attached to the movable sheave 23. On the other hand, in a conventional drive pulley, a centrifugal weight is attached to a movable sheave with a bolt and a nut. For this reason, when the centrifugal weight is attached to the movable sheave with the bolt and the nut, the bolt needs to be fixed using a bolt tool and the nut needs to be fastened using a nut tool. It takes time and effort to attach the centrifugal weight to the movable sheave.

Since the support 50 is disposed on the movable sheave 23, the centrifugal weight 40 is attached to the movable sheave 23 side. With this configuration, when the centrifugal weight 40 is attached to the movable sheave 23 side, the centrifugal weight 40 can be attached to the movable sheave 23 side with the movable sheave 23 moved in the axial direction relative to the drive shaft 21, and the centrifugal weight 40 can be easily attached.

The retaining ring 65 is attached to the inner surface of the first through-hole 511, and determines the position of the first end surface 61a of the first end portion 61 of the pin 60 inside the first through-hole 511. With this configuration, removal of the first end portion 61 of the pin 60 from the first through-hole 511 is prevented. Thus, the length of the pin 60 can be shortened. Moreover, protrusion of the first end portion 61 of the pin 60 from the first through-hole 511 can be prevented, and the drive pulley 20 can be reduced in size.

The bottom portion 522 of the second receiving portion 52 contacts the second end surface 62a of the second end portion 62 of the pin 60 to determine the position of the second end surface 62a inside the second through-hole 521. With this configuration, removal of the second end portion 62 of the pin 60 from the second through-hole 521 is prevented. Thus, the length of the pin 60 can be shortened. Moreover, protrusion of the second end portion 62 of the pin 60 from the second through-hole 521 can be prevented, and the drive pulley 20 can be reduced in size.

The bottom portion 522 has the hole 522a communicating with the second through-hole 521 and having the smaller diameter than the inner diameter of the second through-hole 521. With this configuration, when the second end portion 62 inserted into the second through-hole 521 is taken out of the second through-hole 521, the second end portion 62 can be easily taken out of the second through-hole 521 in such a manner that the second end surface 62a of the second end portion 62 is pushed by an ejector pin inserted into the hole 522a from the outside of the second receiving portion 52. Moreover, when the second end portion 62 is inserted into the second through-hole 521, air inside the second through-hole 521 can be pushed out of the second receiving portion 52 through the hole 522a, and causes no resistance. Thus, the second end portion 62 can be smoothly inserted into the second through-hole 521.

Since the pin 60 is symmetrical with respect to the plane 64 passing the center of the length of the pin 60 and extending perpendicularly to the axis of the pin 60, the shape of the first end portion 61 and the shape of the second end portion 62 are the same as each other. Thus, when the pin 60 is attached to the support 50, each of the first end portion 61 and the second end portion 62 can be attached to any of the first receiving portion 51 and the second receiving portion 52, and therefore, the attachability of the pin 60 is improved. Particularly, even in a case where the structure for determining the position of the pin 60 in the first receiving portion 51 and the structure for determining the position of the pin 60 in the second receiving portion 52 are different from each other, each of the first end portion 61 and the second end portion 62 can be attached to any of the first receiving portion 51 and the second receiving portion 52, and the attachability of the pin 60 is improved.

According to the above-described continuously variable transmission 10, the drive pulley 20 has the retaining ring 65 that prevents removal of the first end portion 61 of the pin 60 from the first through-hole 511. Since the retaining ring 65 is used for preventing removal of the pin 60 in the drive pulley 20, screw loosening can be reduced and the cost can be reduced. Thus, the quality of the continuously variable transmission 10 can be improved, and the cost for the continuously variable transmission 10 can be reduced.

According to the above-described vehicle 100, the drive pulley 20 has the retaining ring 65 that prevents removal of the first end portion 61 of the pin 60 from the first through-hole 511. Since the retaining ring 65 is used for preventing removal of the pin 60 in the drive pulley 20, screw loosening can be reduced and the cost can be reduced. Thus, the quality of the continuously variable transmission 10 can be improved, and the cost for the continuously variable transmission 10 can be reduced. Consequently, the quality of the vehicle 100 can be improved, and the cost for the vehicle 100 can be reduced.

### <<First Modification>>

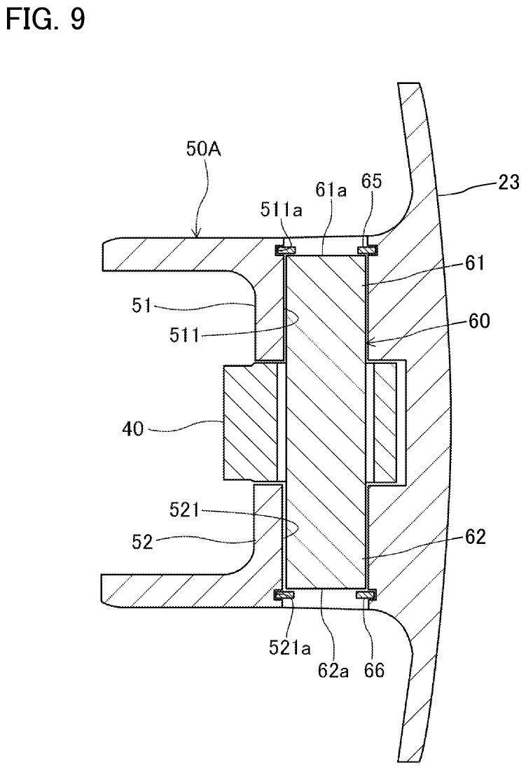

FIG. 9 is a sectional view showing the state of attachment of a support 50A and a pin 60 in a drive pulley according to a first modification. The drive pulley according to the first modification is different from the drive pulley according to the embodiment in the state of attachment of the support 50A and the pin 60. Hereinafter, different configurations of the drive pulley according to the first modification from those of the drive pulley according to the embodiment will be mainly described. Note that the same reference numerals of the drive pulley according to the first modification as those of the drive pulley according to the embodiment indicate the same components as those of the drive pulley according to the embodiment, and therefore, description thereof will be omitted.

The state of attachment of the first receiving portion 51 of the support 50A and the first end portion 61 of the pin 60 is the same as the state of attachment of the first receiving portion 51 of the support 50 and the first end portion 61 of the pin 60 in the embodiment. That is, the retaining ring 65 prevents removal of the first end portion 61 of the pin 60 from the first through-hole 511.

The state of attachment of the second receiving portion 52 of the support 50A and the second end portion 62 of the pin 60 is different from the state of attachment of the second receiving portion 52 of the support 50 and the second end portion 62 of the pin 60 in the embodiment. Specifically, the drive pulley according to the first modification further includes another retaining ring 66. The another retaining ring 66 prevents removal of the second end portion 62 of the pin 60 from the second through-hole 521. The configuration of the another retaining ring 66 is the same as the configuration of the retaining ring 65 of the embodiment. Hereinafter, the another retaining ring 66 will be merely referred to as a “retaining ring 66.”

Of the second through-hole 521 of the second receiving portion 52 of the support 50A, an end portion opposite to an end portion on the first receiving portion 51 side is opened without the bottom portion 522 of the embodiment. The retaining ring 66 is attached to the inner surface of the second through-hole 521, and contacts the second end surface 62a of the second end portion 62 of the pin 60 to determine the position of the second end surface 62a inside the second through-hole 521. Specifically, the second through-hole 521 has, in the inner surface thereof, a groove 521a. The groove 521a extends in the circumferential direction about the axis of the second through-hole 521. The retaining ring 66 is fitted in the groove 521a. Specifically, an outer peripheral portion of the retaining ring 66 is fitted in the groove 521a, and an inner peripheral portion of the retaining ring 66 contacts the second end surface 62a. With this configuration, removal of the pin 60 from the second through-hole 521 in the direction opposite to the first receiving portion 51 is restricted.

The retaining ring 66 is detachably attached to the groove 521a. Specifically, the inner diameter of the retaining ring 66 is decreased with a tool such as pliers inserted into holes in both ends of the retaining ring 66, and in this manner, the retaining ring 66 can be detached from the groove 521a. By a similar process, the detached retaining ring 66 can be attached to the groove 521a.

According to the drive pulley of the first modification, since the retaining rings 65, 66 are used for preventing removal of the first end portion 61 and second end portion 62 of the pin 60, the cost can be further reduced without screw loosening.

The retaining ring 66 is attached to the inner surface of the second through-hole 521, and determines the position of the second end surface 62a of the second end portion 62 of the pin 60 inside the second through-hole 521. With this configuration, removal of the second end portion 62 of the pin 60 from the second through-hole 521 is prevented. Thus, the length of the pin 60 can be shortened. Moreover, protrusion of the second end portion 62 of the pin 60 from the second through-hole 521 can be prevented, and the drive pulley 20 can be reduced in size.

Note that description of other configurations, features, and effects will be omitted, but description of the drive pulley according to the embodiment may be applied to description of the drive pulley according to the modification.

### <<Second Modification>>

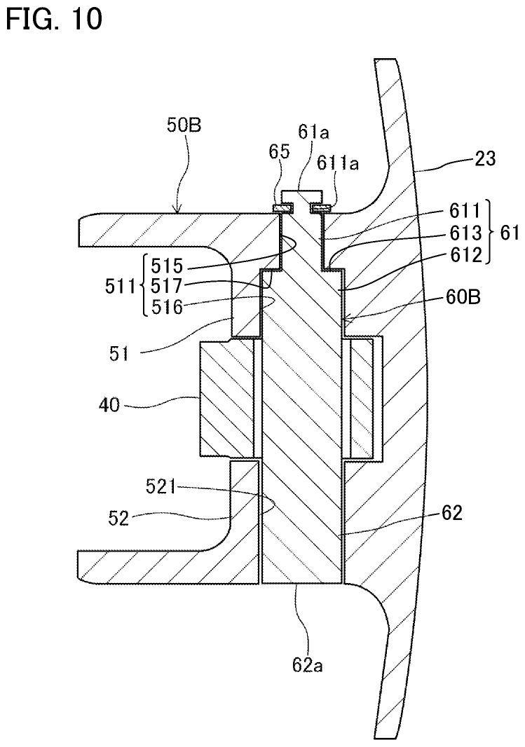

FIG. 10 is a sectional view showing the state of attachment of a support 50B and a pin 60B in a drive pulley according to a second modification. The drive pulley according to the second modification is different from the drive pulley according to the embodiment in the state of attachment of the support 50B and the pin 60B. Hereinafter, different configurations of the drive pulley according to the second modification from those of the drive pulley according to the embodiment will be mainly described. Note that the same reference numerals of the drive pulley according to the second modification as those of the drive pulley according to the embodiment indicate the same components as those of the drive pulley according to the embodiment, and therefore, description thereof will be omitted.

The first through-hole 511 of the first receiving portion 51 of the support 50B includes a first portion 515 and a second portion 516. The second portion 516 is positioned on the second receiving portion 52 side with respect to the first portion 515. The inner diameter of the first portion 515 is smaller than the inner diameter of the second portion 516. There is a step 517 between the first portion 515 and the second portion 516.

Of the second through-hole 521 of the second receiving portion 52 of the support 50B, an end portion opposite to an end portion on the first receiving portion 51 side is opened without the bottom portion 522 of the embodiment.

The first end portion 61 of the pin 60B includes a first portion 611 and a second portion 612. The second portion 612 is positioned on the second end portion 62 side with respect to the first portion 611. The outer diameter of the first portion 611 is smaller than the outer diameter of the second portion 612. There is a step 613 between the first portion 611 and the second portion 612.

In a state of the first end portion 61 of the pin 60B being inserted into the first through-hole 511 of the first receiving portion 51, the first portion 611 of the first end portion 61 is fitted in the first portion 515 of the first through-hole 511, the second portion 612 of the first end portion 61 is fitted in the second portion 516 of the first through-hole 511, and the step 613 of the first end portion 61 contacts the step 517 of the first through-hole 511. With this configuration, removal of the pin 60B from the first through-hole 511 in the direction opposite to the second receiving portion 52 is restricted.

A tip end portion of the first portion 611 of the first end portion 61 protrudes from the first through-hole 511. The first portion 611 has, in the outer periphery of the tip end portion thereof, a groove 611a. The groove 611a extends in the circumferential direction about the axis of the pin 60B. The retaining ring 65 is fitted in the groove 611a. The retaining ring 65 is positioned outside the first through-hole 511. The retaining ring 65 contacts the side surface of the first receiving portion 51. With this configuration, removal of the pin 60B from the first through-hole 511 in the direction toward the second receiving portion 52 is restricted.

According to the drive pulley of the second modification, since the retaining ring 65 is used for preventing removal of the first end portion 61 of the pin 60B, screw loosening can be reduced and the cost can be reduced. Moreover, since the retaining ring 65 is positioned outside the first through-hole 511, attachment of the retaining ring 65 to the pin 60B and detachment of the retaining ring 65 from the pin 60B are facilitated.

Note that description of other configurations, features, and effects will be omitted, but description of the drive pulley according to the embodiment may be applied to description of the drive pulley according to the modification.

### <<Third Modification>>

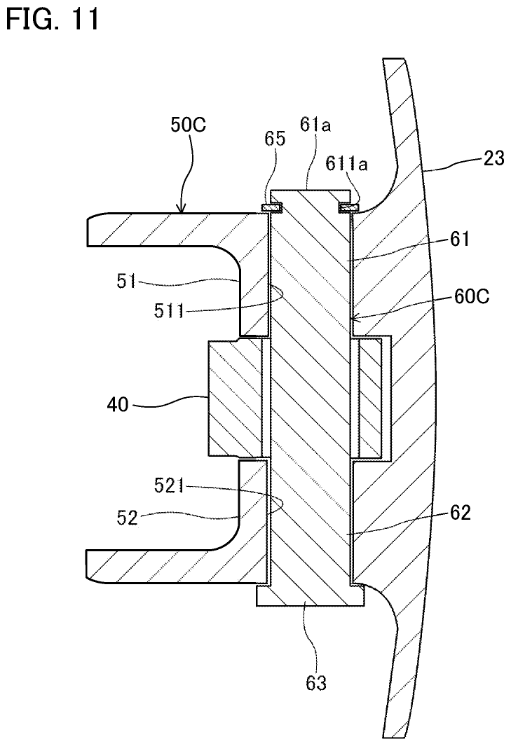

FIG. 11 is a sectional view showing the state of attachment of a support 50C and a pin 60C in a drive pulley according to a third modification. The drive pulley according to the third modification is different from the drive pulley according to the embodiment in the state of attachment of the support 50C and the pin 60C. Hereinafter, different configurations of the drive pulley according to the third modification from those of the drive pulley according to the embodiment will be mainly described. Note that the same reference numerals of the drive pulley according to the third modification as those of the drive pulley according to the embodiment indicate the same components as those of the drive pulley according to the embodiment, and therefore, description thereof will be omitted.

The first through-hole 511 of the first receiving portion 51 of the support 50C does not have the groove 511a of the embodiment. Of the second through-hole 521 of the second receiving portion 52 of the support 50C, an end portion opposite to an end portion on the first receiving portion 51 side is opened without the bottom portion 522 of the embodiment.

The pin 60C has, at the second end portion 62 thereof, a head 63. The outer diameter of the head 63 is greater than the outer diameter of the second end portion 62.

In a state of the pin 60C being inserted into the first through-hole 511 and the second through-hole 521, a tip end portion of the first end portion 61 protrudes from the first through-hole 511. The first portion 611 has, in the outer periphery of the tip end portion thereof, the groove 611a. The groove 611a extends in the circumferential direction about the axis of the pin 60C. The retaining ring 65 is fitted in the groove 611a. The retaining ring 65 is positioned outside the first through-hole 511. The retaining ring 65 contacts the side surface of the first receiving portion 51. With this configuration, removal of the pin 60C from the first through-hole 511 in the direction toward the second receiving portion 52 is restricted.

The head 63 is positioned outside the second through-hole 521. The head 63 contacts the side surface of the second receiving portion 52. With this configuration, removal of the pin 60C from the second through-hole 521 in the direction toward the first receiving portion 51 is restricted.

According to the drive pulley of the third modification, since the retaining ring 65 is used for preventing removal of the first end portion 61 of the pin 60C, screw loosening can be reduced, and the cost can be reduced. Moreover, since the retaining ring 65 is positioned outside the first through-hole 511, attachment of the retaining ring 65 to the pin 60C and detachment of the retaining ring 65 from the pin 60C are facilitated.

Note that description of other configurations, features, and effects will be omitted, but description of the drive pulley according to the embodiment may be applied to description of the drive pulley according to the modification.

### Other Embodiments

The embodiment has been described above as an example of the technique disclosed in the present application. However, the technique in the present disclosure is not limited to above, and is also applicable to embodiments to which changes, replacements, additions, omissions, etc. are made as necessary. The components described above in the embodiment may be combined to form a new embodiment. The components shown in the attached drawings and described in detail may include not only components essential for solving the problems, but also components that are provided for describing an example of the above-described technique and are not essential for solving the problems. Thus, description of these non-essential components in detail and illustration of these components in the attached drawings shall not be interpreted that these non-essential components are essential. For example, the off-road vehicle is not limited to the utility vehicle 100. The off-road vehicle may be, for example, an all terrain vehicle (ATV) or a tractor. Moreover, the off-road vehicle is not limited to the four-wheeled vehicle, and for example, may be a three-wheeled vehicle.

The support 50 is disposed on the movable sheave 23, but the support 50 may be disposed on the spider 24. In this case, the centrifugal weight 40 is attached to the spider 24 side, and turns by rotation of the drive shaft 21 to press the movable sheave 23. The roller 31 may be disposed on the movable sheave 23.

The bottom portion 522 of the second receiving portion 52 has the hole 522a, but may be closed without the hole 522a.

In a case where the retaining rings 65, 66 are each used for the first end portion 61 and second end portion 62 of the pin 60, the retaining rings 65, 66 are not necessarily located inside the first through-hole 511 and the second through-hole 521, and the retaining ring 65, 66 may be located outside at least one of the first through-hole 511 or the second through-hole 521.

For example, removal of the first end portion 61 is prevented by the retaining ring 65 inside the first through-hole 511, and removal of the second end portion 62 is prevented by the retaining ring 66 outside the second through-hole 521.

Alternatively, removal of the first end portion 61 is prevented by the retaining ring 65 outside the first through-hole 511, and removal of the second end portion 62 is prevented by the retaining ring 66 inside the second through-hole 521. Alternatively, removal of the first end portion 61 is prevented by the retaining ring 65 outside the first through-hole 511, and removal of the second end portion 62 is prevented by the retaining ring 66 outside the second through-hole 521.

### [Aspects]

The above-described embodiment is a specific example of the following aspects.

### (First Aspect)

The drive pulley 20 for the continuously variable transmission includes the drive shaft 21, the fixed sheave 22 fixed to the drive shaft 21 in the axial direction and the circumferential direction, the movable sheave 23 movable in the axial direction relative to the drive shaft 21 and fixed to the drive shaft 21 in the circumferential direction, the spider 24 fixed to the drive shaft 21 in the axial direction and the circumferential direction, the support 50 disposed on one of the movable sheave 23 or the spider 24 and including the first receiving portion 51 and the second receiving portion 52 located apart from each other, the pin 60 including the first end portion 61 supported on the first receiving portion 51 with inserted into the first through-hole 511 of the first receiving portion 51 and the second end portion 62 supported on the second receiving portion 52 with inserted into the second through-hole 521 of the second receiving portion 52, the centrifugal weight 40 located between the first receiving portion 51 and the second receiving portion 52, attached to the pin 60 so as to turn according to centrifugal force generated by rotation of the drive shaft 21, and turning by rotation of the drive shaft 21 to press the other one of the movable sheave 23 or the spider 24 and move the movable sheave 23 in the axial direction, and the retaining ring 65 preventing removal of the first end portion 61 of the pin 60 from the first through-hole 511.

According to this configuration, the drive pulley 20 has the retaining ring 65 that prevents removal of the first end portion 61 of the pin 60 from the first through-hole 511. Since the retaining ring 65 is used for preventing removal of the pin 60 as described above, screw loosening can be reduced and the cost can be reduced.

### (Second Aspect)

In the drive pulley 20 for the continuously variable transmission according to the first aspect, the support 50 is disposed on the movable sheave 23.

According to this configuration, since the support 50 is disposed on the movable sheave 23, the centrifugal weight 40 is attached to the movable sheave 23 side. With this configuration, when the centrifugal weight 40 is attached to the movable sheave 23 side, the centrifugal weight 40 can be attached to the movable sheave 23 side with the movable sheave 23 moved in the axial direction relative to the drive shaft 21 and the centrifugal weight 40 can be easily attached.

### (Third Aspect)

In the drive pulley 20 for the continuously variable transmission according to the first or second aspect, the retaining ring 65 is attached to the inner surface of the first through-hole 511, and contacts the first end surface 61a of the first end portion 61 of the pin 60 to determine the position of the first end surface 61a inside the first through-hole 511.

According to this configuration, the retaining ring 65 is attached to the inner surface of the first through-hole 511, and determines the position of the first end surface 61a of the first end portion 61 of the pin 60 inside the first through-hole 511. With this configuration, removal of the first end portion 61 of the pin 60 from the first through-hole 511 is prevented. Thus, the length of the pin 60 can be shortened. Moreover, protrusion of the first end portion 61 of the pin 60 from the first through-hole 511 can be prevented, and the drive pulley 20 can be reduced in size.

### (Fourth Aspect)

In the drive pulley 20 for the continuously variable transmission according to any one of the first to third aspects, the second receiving portion 52 has the bottom portion 522 at the end portion of the second through-hole 521 opposite to the end portion on the first receiving portion 51 side, and the bottom portion 522 contacts the second end surface 62a of the second end portion 62 of the pin 60 to determine the position of the second end surface 62a inside the second through-hole 521.

According to this configuration, the bottom portion 522 of the second receiving portion 52 contacts the second end surface 62a of the second end portion 62 of the pin 60, and determines the position of the second end surface 62a inside the second through-hole 521. With this configuration, removal of the second end portion 62 of the pin 60 from the second through-hole 521 is prevented. Thus, the length of the pin 60 can be shortened. Moreover, protrusion of the second end portion 62 of the pin 60 from the second through-hole 521 can be prevented, and the drive pulley 20 can be reduced in size.

### (Fifth Aspect)

In the drive pulley 20 for the continuously variable transmission according to any one of the first to fourth aspects, the bottom portion 522 has the hole 522a communicating with the second through-hole 521 and having the smaller diameter than the inner diameter of the second through-hole 521.

According to this configuration, the bottom portion 522 has the hole 522a communicating with the second through-hole 521 and having the smaller diameter than the inner diameter of the second through-hole 521. With this configuration, when the second end portion 62 inserted into the second through-hole 521 is taken out of the second through-hole 521, the second end portion 62 can be easily taken out of the second through-hole 521 in such a manner that the second end surface 62a of the second end portion 62 is pushed by the ejector pin inserted into the hole 522a from the outside of the second receiving portion 52. Moreover, when the second end portion 62 is inserted into the second through-hole 521, air inside the second through-hole 521 can be pushed out of the second receiving portion 52 through the hole 522a, and causes no resistance. Thus, the second end portion 62 can be smoothly inserted into the second through-hole 521.

### (Sixth Aspect)

In the drive pulley 20 for the continuously variable transmission according to any one of the first to fifth aspects, the pin 60 is symmetrical with respect to the plane 64 passing the center of the length of the pin 60 in the axial direction and extending perpendicularly to the axis of the pin 60.

According to this configuration, since the pin 60 is symmetrical with respect to the plane 64 passing the center of the length of the pin 60 and extending perpendicularly to the axis of the pin 60, the shape of the first end portion 61 and the shape of the second end portion 62 are the same as each other. Thus, when the pin 60 is attached to the support 50, each of the first end portion 61 and the second end portion 62 can be attached to any of the first receiving portion 51 and the second receiving portion 52, and therefore, the attachability of the pin 60 is improved.

### (Seventh Aspect)

The drive pulley 20 for the continuously variable transmission according to any one of the first to sixth aspects further includes the another retaining ring 66 preventing removal of the second end portion 62 of the pin 60 from the second through-hole 521.

According to this configuration, since the retaining rings 65, 66 are used for preventing removal of the first end portion 61 and second end portion 62 of the pin 60, the cost can be further reduced without screw loosening.

### (Eighth Aspect)

The continuously variable transmission 10 includes the drive pulley 20 receiving the torque from the engine 7 (drive source), the driven pulley 70 outputting the torque to the wheels 2 (drive wheels), and the belt 13 wound between the drive pulley 20 and the driven pulley 70. The drive pulley 20 for the continuously variable transmission includes the drive shaft 21, the fixed sheave 22 fixed to the drive shaft 21 in the axial direction and the circumferential direction, the movable sheave 23 movable in the axial direction relative to the drive shaft 21 and fixed to the drive shaft 21 in the circumferential direction, the spider 24 fixed to the drive shaft 21 in the axial direction and the circumferential direction, the support 50 disposed on one of the movable sheave 23 or the spider 24 and including the first receiving portion 51 and the second receiving portion 52 located apart from each other, the pin 60 including the first end portion 61 supported on the first receiving portion 51 with inserted into the first through-hole 511 of the first receiving portion 51 and the second end portion 62 supported on the second receiving portion 52 with inserted into the second through-hole 521 of the second receiving portion 52, the centrifugal weight 40 located between the first receiving portion 51 and the second receiving portion 52, attached to the pin 60 so as to turn according to centrifugal force generated by rotation of the drive shaft 21, and turning by rotation of the drive shaft 21 to press the other one of the movable sheave 23 or the spider 24 and move the movable sheave 23 in the axial direction, and the retaining ring 65 preventing removal of the first end portion 61 of the pin 60 from the first through-hole 511.

According to this configuration, the drive pulley 20 has the retaining ring 65 that prevents removal of the first end portion 61 of the pin 60 from the first through-hole 511. Since the retaining ring 65 is used for preventing removal of the pin 60 in the drive pulley 20, screw loosening can be reduced and the cost can be reduced. Thus, the quality of the continuously variable transmission 10 can be improved, and the cost for the continuously variable transmission 10 can be reduced.

### (Ninth Aspect)

The utility vehicle 100 (off-road vehicle) includes the engine 7 (drive source), the wheels 2 (drive wheels), and the continuously variable transmission 10 transmitting the torque of the engine 7 to the wheels 2. The continuously variable transmission 10 includes the drive pulley 20 receiving the torque from the engine 7, the driven pulley 70 outputting the torque to the wheels 2, and the belt 13 wound between the drive pulley 20 and the driven pulley 70. The drive pulley 20 for the continuously variable transmission includes the drive shaft 21, the fixed sheave 22 fixed to the drive shaft 21 in the axial direction and the circumferential direction, the movable sheave 23 movable in the axial direction relative to the drive shaft 21 and fixed to the drive shaft 21 in the circumferential direction, the spider 24 fixed to the drive shaft 21 in the axial direction and the circumferential direction, the support 50 disposed on one of the movable sheave 23 or the spider 24 and including the first receiving portion 51 and the second receiving portion 52 located apart from each other, the pin 60 including the first end portion 61 supported on the first receiving portion 51 with inserted into the first through-hole 511 of the first receiving portion 51 and the second end portion 62 supported on the second receiving portion 52 with inserted into the second through-hole 521 of the second receiving portion 52, the centrifugal weight 40 located between the first receiving portion 51 and the second receiving portion 52, attached to the pin 60 so as to turn according to centrifugal force generated by rotation of the drive shaft 21, and turning by rotation of the drive shaft 21 to press the other one of the movable sheave 23 or the spider 24 and move the movable sheave 23 in the axial direction, and the retaining ring 65 preventing removal of the first end portion 61 of the pin 60 from the first through-hole 511.

According to this configuration, the drive pulley 20 has the retaining ring 65 that prevents removal of the first end portion 61 of the pin 60 from the first through-hole 511. Since the retaining ring 65 is used for preventing removal of the pin 60 in the drive pulley 20, screw loosening can be reduced and the cost can be reduced. Thus, the quality of the continuously variable transmission 10 can be improved, and the cost for the continuously variable transmission 10 can be reduced. Consequently, the quality of the utility vehicle 100 can be improved, and the cost for the utility vehicle 100 can be reduced.

1. A drive pulley for a continuously variable transmission, comprising:
a drive shaft;
a fixed sheave fixed to the drive shaft in an axial direction and a circumferential direction;
a movable sheave movable in the axial direction relative to the drive shaft and fixed to the drive shaft in the circumferential direction;
a spider fixed to the drive shaft in the axial direction and the circumferential direction;
a support disposed on one of the movable sheave or the spider and including a first receiving portion and a second receiving portion located apart from each other;
a pin including a first end portion supported on the first receiving portion by being inserted into a first through-hole of the first receiving portion and a second end portion supported on the second receiving portion by being inserted into a second through-hole of the second receiving portion;
a centrifugal weight located between the first receiving portion and the second receiving portion, attached to the pin so as to turn according to centrifugal force generated by rotation of the drive shaft, and turning by rotation of the drive shaft to press the other one of the movable sheave or the spider and move the movable sheave in the axial direction; and
a retaining ring preventing removal of the first end portion of the pin from the first through-hole, wherein
an outer peripheral portion of the retaining ring is fitted in a groove of the first through-hole, and an inner peripheral portion of the retaining ring contacts the first end surface of the first end portion of the pin to determine the position of the first end surface inside the first through-hole,
the second receiving portion has a bottom portion at an end portion of the second through-hole opposite to an end portion on a first receiving portion side,
the bottom portion contacts a second end surface of the second end portion of the pin to determine a position of the second end surface inside the second through-hole,
the bottom portion has a hole communicating with the second through-hole and having a smaller diameter than an inner diameter of the second through-hole, and
the second end surface of the second end portion of the pin is exposed from the hole of the bottom portion.

2. The drive pulley for the continuously variable transmission according to claim 1,
wherein the support is disposed on the movable sheave.

3. (canceled)

4. (canceled)

5. (canceled)

6. The drive pulley for the continuously variable transmission according to claim 1, wherein
the pin is symmetrical with respect to a plane passing a center of a length of the pin in the axial direction and extending perpendicularly to an axis of the pin.

7. The drive pulley for the continuously variable transmission according to claim 1, further comprising:
another retaining ring preventing removal of the second end portion of the pin from the second through-hole.

8. A continuously variable transmission comprising:
a drive pulley receiving torque from a drive source;
a driven pulley outputting the torque to a drive wheel; and
a belt wound between the drive pulley and the driven pulley,
wherein the drive pulley includes
a drive shaft,
a fixed sheave fixed to the drive shaft in an axial direction and a circumferential direction,
a movable sheave movable in the axial direction relative to the drive shaft and fixed to the drive shaft in the circumferential direction,
a spider fixed to the drive shaft in the axial direction and the circumferential direction,
a support disposed on one of the movable sheave or the spider and including a first receiving portion and a second receiving portion located apart from each other,
a pin including a first end portion supported on the first receiving portion by being inserted into a first through-hole of the first receiving portion and a second end portion supported on the second receiving portion by being inserted into a second through-hole of the second receiving portion,
a centrifugal weight located between the first receiving portion and the second receiving portion, attached to the pin so as to turn according to centrifugal force generated by rotation of the drive shaft, and turning by rotation of the drive shaft to press the other one of the movable sheave or the spider and move the movable sheave in the axial direction, and
a retaining ring preventing removal of the first end portion of the pin from the first through-hole, wherein
an outer peripheral portion of the retaining ring is fitted in a groove of the first through-hole, and an inner peripheral portion of the retaining ring contacts the first end surface of the first end portion of the pin to determine the position of the first end surface inside the first through-hole,
the second receiving portion has a bottom portion at an end portion of the second through-hole opposite to an end portion on a first receiving portion side,
the bottom portion contacts a second end surface of the second end portion of the pin to determine a position of the second end surface inside the second through-hole,
the bottom portion has a hole communicating with the second through-hole and having a smaller diameter than an inner diameter of the second through-hole, and
the second end surface of the second end portion of the pin is exposed from the hole of the bottom portion.

9. An off-road vehicle comprising:
a drive source;
a drive wheel; and
a continuously variable transmission transmitting torque of the drive source to the drive wheel,
wherein the continuously variable transmission includes
a drive pulley receiving the torque from the drive source,
a driven pulley outputting the torque to the drive wheel, and
a belt wound between the drive pulley and the driven pulley, and
the drive pulley includes
a drive shaft,
a fixed sheave fixed to the drive shaft in an axial direction and a circumferential direction,
a movable sheave movable in the axial direction relative to the drive shaft and fixed to the drive shaft in the circumferential direction,
a spider fixed to the drive shaft in the axial direction and the circumferential direction,
a support disposed on one of the movable sheave or the spider and including a first receiving portion and a second receiving portion located apart from each other,
a pin including a first end portion supported on the first receiving portion by being inserted into a first through-hole of the first receiving portion and a second end portion supported on the second receiving portion by being inserted into a second through-hole of the second receiving portion,
a centrifugal weight located between the first receiving portion and the second receiving portion, attached to the pin so as to turn according to centrifugal force generated by rotation of the drive shaft, and turning by rotation of the drive shaft to press the other one of the movable sheave or the spider and move the movable sheave in the axial direction, and
a retaining ring preventing removal of the first end portion of the pin from the first through-hole, wherein
an outer peripheral portion of the retaining ring is fitted in a groove of the first through-hole, and an inner peripheral portion of the retaining ring contacts the first end surface of the first end portion of the pin to determine the position of the first end surface inside the first through-hole,
the second receiving portion has a bottom portion at an end portion of the second through-hole opposite to an end portion on a first receiving portion side,
the bottom portion contacts a second end surface of the second end portion of the pin to determine a position of the second end surface inside the second through-hole,
the bottom portion has a hole communicating with the second through-hole and having a smaller diameter than an inner diameter of the second through-hole, and
the second end surface of the second end portion of the pin is exposed from the hole of the bottom portion.

10-13. (canceled)
